(19) United States
(12) Patent Application Publication
(10) Pub. No.: US 2006/0090138 A1
(43) Pub. Date: Apr. 27, 2006

(54) Method and apparatus for providing DHTML accessibility

(76) Inventors: Steve Wang, Cary, NC (US); Richard Scott Schwerdtfeger, Round Rock, TX (US); Becky Jean Gibson, Westford, MA (US); Aaron M. Leventhal, Arlington, MA (US)

Correspondence Address: LOTUS AND RATIONAL SOFTWARE;STEUBING MCGUINNESS, 125 NAGOG PARK, ACTON, MA, 01720, US

(21) Appl. No.: 10/968,575

(22) Filed: Oct. 19, 2004

(51) Int. Cl. G06F 17/00; G06F 3/00; G06F 9/00

(52) U.S. Cl. 715/760

(57) ABSTRACT

A system for providing DHTML (“Dynamic Hyper-Text Markup Language”) accessibility. Rich keyboard and other assistive technology (“AT”) accessibility is provided for sophisticated Web applications. When a user downloads a Web page, the system performs initialization that includes loading at least one display object, and binding the object to a predetermined event, such as, for example, a focus event. The event the object is bound to may be any semantic, device independent event. The disclosed system may also load a device handling function, such as a keyboard handling function. The device handling function associates one or more display objects with corresponding device actions, such as key presses. A keyboard handling function may operate to intercept at least one key press, and determine that an intercepted key press matches a key press corresponding to a previously loaded display object. The device handling function may create a focus event for the previously loaded display object, and post the event to the display object. The display object then handles the event by visually responding to the intercepted key press, for example by changing the visual representation of the display object to be highlighted, or to otherwise indicate that the display object has been selected. The event may then also be sent to an assistive technology program, such as a screen reader program. Using the values of attributes in that display object, such as the value of the role attribute, the assistive technology program responds to the event as appropriate.

### FIELD OF THE INVENTION

The present invention relates generally to user interfaces and Web-based applications, and more specifically to a method and system for providing DHTML (“Dynamic Hyper-Text Markup Language”) accessibility.

### BACKGROUND OF THE INVENTION

In consideration of users having a range of capabilities and preferences, it is desirable for user interfaces to provide a full range of access options, including mouse, keyboard, and assistive technology accessibility. Assistive technologies are alternative access solutions, like screen readers for the blind, which are used to help persons with impairments. In particular, visually impaired users may have difficulty using a mouse, and rely on keyboard and screen reader access to interact with a computer. A screen reader program is software that assists a visually impaired user by reading the contents of a computer screen, and converting the text to speech. An example of an existing screen reader program is the JAWS® program offered by Freedom Scientific® corporation. Additionally, users other than the visually impaired may not be able to use a mouse, for example as a result of an injury or disability, and may need an interface providing keyboard access as an alternative to mouse access. With the growing importance of content provided over the World Wide Web (“Web”), there is especially a need to provide full keyboard and screen reader access to Web pages, in addition to mouse click access.

As it is generally known, the World Wide Web (“Web”) is a major service on the Internet. Computer systems acting as Web server systems store Web page documents that may include text, graphics, animations, videos, and other content. Web pages are accessed by users via Web browser software, such as Internet Explorer® provided by Microsoft, or Netscape Navigator®, provided by America Online (AOL), and others. The browser program renders Web pages on the user's screen, and automatically invokes additional software as needed.

HyperText Mark-up Language (“HTML”) is often used to format content presented on the Web. The HTML for a Web page defines page layout, fonts and graphic elements, as well as hypertext links to other documents on the Web. A Web page is typically built using HTML “tags” embedded within the text of the page. An HTML tag is a code or command used to define a format change or hypertext link. HTML tags are surrounded by the angle brackets “<” and “>”.

More recently, Dynamic HTML (“DHTML”) has been introduced. DHTML may be considered a combination of HTML enhancements, scripting language (such as JavaScript) and interface that supports delivery of animations, styling using Cascading Style Sheets (CSS), interactions and dynamic updating on Web pages. The Document Object Model (“DOM”) DOM is an example of a DHTML interface that presents an HTML document to the programmer as an object model. DOM specifies an Application Programming Interface (API) that allows programs and scripts to update the content, structure and style of HTML and XML (“extensible Mark-up Language”) documents. Included in Web browser software, a DOM implementation further provides functions that enable scripting language scripts to access browser elements, such as windows and history.

A problem currently exists in that while Web content incorporating JavaScript is found on the majority of all Web sites today, it is not fully accessible to many disabled persons that are keyboard users. This dramatically affects the ability of persons with disabilities to access Web content. Currently, the W3C (World Wide Web Consortium) requires Web page authors to create alternative accessible content, rather than solving the JavaScript accessibility problem. Existing Web browsers allow keyboard users to press the Tab key to traverse HTML elements that can have focus, or that are clickable, such as HTML link, button, text area, etc. This is sufficient for simple HTML pages, providing some accessibility through Assistive Technologies (AT) such as a screen reader program. However, for more sophisticated DHTML Web applications, for example those having menu and toolbar elements, Tab key support alone does not allow the desired User Interface (UI) experience. Thus, DHTML element keyboard accessibility may be limited, preventing some Web products from satisfying United States government regulations regarding accessibility. Additionally, new legislation being adopted by the European Union prohibits the use of JavaScript in some cases because of these accessibility problems.

In particular, sophisticated client Web applications have emerged, using JavaScript and DOM functionality to construct text, spreadsheet and presentation editors. These Web applications may have classic desktop application appearances, and include display objects such as menus, toolbars etc. Keyboard access and associated assistive technologies may break down with these types of applications, due to the use of dynamic elements such as <div> or <span>.

Accordingly, it would be desirable to have a new system that enables access for sophisticated Web applications that is not limited to Tab keying. In particular, it would be desirable to enable a user to more easily open and traverse display objects such as menus, toolbars, and the like. The new system should support assistive technologies, such as a screen reader program that plays out descriptive audio corresponding to the selected display objects. Moreover, the new system should be generally applicable to any display objects, including display objects requiring navigation within them, using any specific key strokes.

### SUMMARY OF THE INVENTION

To help address the above described and other shortcomings of previous systems, a method and a system for providing DHTML (“Dynamic Hyper-Text Markup Language”) accessibility are disclosed. In the disclosed system, rich keyboard and: other assistive technology (“AT”) accessibility is provided for sophisticated Web applications. When a user downloads a Web page, the disclosed system performs initialization that includes loading at least one display object, and binding the object to a predetermined event, such as, for example, a focus event. The event the object is bound to may be any semantic, device independent event. The disclosed system may also load a device handling function, such as a keyboard handling function. The device handling function associates one or more display objects with corresponding device actions, such as key presses.

For example, a keyboard handling function may operate to intercept at least one key press, and determine that an intercepted key press matches a key press corresponding to a previously loaded display object. The keyboard handling function creates a focus event for the previously loaded display object, and posts the event to the display object. The display object then handles the event by visually responding to the intercepted key press, for example by changing the visual representation of the display object to be highlighted, or to otherwise indicate that the display object has been selected. The event may then also be sent to an assistive technology program, such as a screen reader program. The assistive technology program intercepts the event, and determines the display object currently having focus. Using the values of attributes in that display object, such as the value of the role attribute, the assistive technology program responds to the event as appropriate. For example, a screen reader program may generate speech audio audibly describing the visual change in the user interface. Based on such indication from the assistive technology program, the user may then use other appropriate key presses, such as arrow keys, to perform further user interface navigation as needed.

In a further aspect, the disclosed system enables a user to use the ctrl-shift-m keystroke combination to invoke a menu or main toolbar of a display object. The ctrl-shift-m combination has not previously been allocated by popular browser applications for the Windows and Linux operating systems. Accordingly, the disclosed use of ctrl-shift-m in this regard advantageously enables development of a standardized interface. A standardized interface based on this key press combination would allow keyboard users to immediately begin interacting with these Web component display objects without having to first find and read documentation to determine what keystroke combinations have been implemented.

Thus there is disclosed a new system that enables keyboard access for sophisticated Web applications, and that is not limited to Tab keying. The disclosed system enables various input/output device users, such as a keyboard user, to open and traverse display objects such as menus, toolbars, and the like. The disclosed system supports assistive technologies, such as screen reader programs that play out audio describing selected display objects. The disclosed system is generally applicable to any specific type of display object, including display objects requiring navigation using specific key strokes such as arrow keys. Furthermore, this technique allows Web pages to approach the usability found in Graphical User Interfaces (GUIs) such as Windows.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram representation of components and devices in an execution environment of an illustrative embodiment of the disclosed system;

FIG. 2 is a flow chart illustrating steps performed during operation of an embodiment of the disclosed system;

FIG. 3 shows a portion of a screen shot illustrating keyboard access provided by an embodiment of the disclosed system;

FIG. 4 shows a first code example from an embodiment of the disclosed system;

FIG. 5 shows a second code example from an embodiment of the disclosed system;

FIG. 6 shows a third code example from an embodiment of the disclosed system;

FIG. 7 shows a portion of a screen shot illustrating a first use case for an embodiment of the disclosed system;

FIG. 8 shows a portion of a screen shot illustrating a second use for an embodiment of the disclosed system; and

FIG. 9 shows a fourth code example from an embodiment of the disclosed system.

### DETAILED DESCRIPTION OF EXEMPLARY EMBODIMENTS

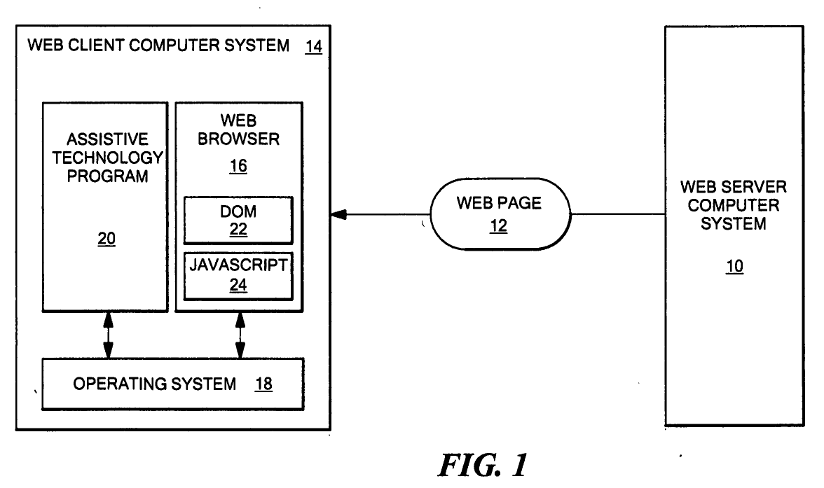

As shown in the block diagram of FIG. 1, components and devices in an execution environment of an illustrative embodiment of the disclosed system include a Web server computer system 10 operable to transmit a Web page 12 over the Internet to a Web client computer system 14. Upon receipt of the Web page 12, the Web client computer system 14 loads the contents of the Web page 12 into a Web browser program 16, which is shown containing a Document Object Model (DOM) 22 and JavaScript engine 24. The Web browser program 16 may be any specific type of Web browser program, such as Internet Explorer provided by Microsoft® Corporation, Netscape Navigator provided by Netscape Communications Corporation, or the like. The Web server computer system 10 and Web client computer system 14 may be any specific type of computer system or other programmable device including one or more processors, program storage memory for storing program code executable on the processor, input/output devices such as communication and/or network adapters or interfaces, removable program storage media devices, etc.

The Web client computer system further includes an operating system 18 communicable with the Web browser 16 and some number of other programs, including an assistive technology program 20, such as a screen reader program. The operating system 18 may be any specific type of computer operating system, examples of which include those operating systems provided by IBM Corporation, Microsoft® Corporation, or Apple Computer, Inc., variants of the UNIX operating system, and others. During operation of the disclosed system, the Web page 12 is received, interpreted and run by the Web browser 16 in the Web client computer system 12 in the context of a running Web application program.

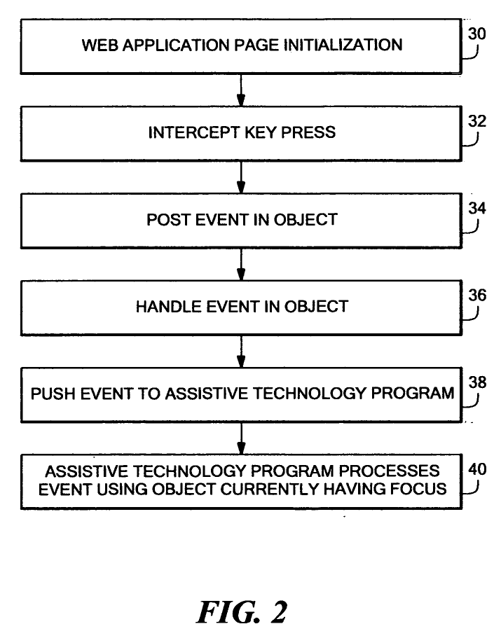

FIG. 2 is a flow chart illustrating steps performed during operation of an embodiment of the disclosed system. When a user downloads a Web page, for example as part of using a Web application program, the disclosed system operates by first performing initialization at step 30 that includes parsing a document into a DOM and loading and binding at least one display object to a predetermined focus event indicating that the display object has been selected by the user, and loading a keyboard handling function. The display object may be any specific type of display object. The focus event the display object is bound to may, for example, be any event that is used to give notice of the display object gaining focus in the user interface, such as the DOMFocusin event provided by the DOM implementation 22 shown in FIG. 1 or any compatible focus event that applies to all HTML elements. The keyboard handling function may be any specific type of function operable to check key presses for predetermined individual keys, key combinations, key sequences, or other keyboard events. One or more display objects may be associated with corresponding key presses or combinations through the keyboard handling function.

Next, at step 32, the disclosed system operates to intercept a key press and determine whether the intercepted key press matches a predetermined key press corresponding to a previously loaded display object. If so, in response, the keyboard handling function creates the focus event bound to the previously loaded display object, and posts the event to the display object at step 34. The display object then handles the event at step 36 to visually respond to the intercepted key press, for example by changing the visual representation of the display object to be highlighted or otherwise indicative of the display object having been selected by the user.

At step 38 the disclosed system pushes the focus event information, which may for example be a DOMFocusin event, into an event queue to communicate the event from the browser program to an assistive technology program, such as a screen reader. The transfer of the event information to the assistive technology program may be accomplished through any specific mechanism, such as, for example, Microsoft Active Accessibility (MSAA)'s OBJ_FOCUS event. MSAA is just one example of a software interface that may be used with the disclosed system to enable each display object (window, dialog box, menu button, tool bar, etc.) in the user interface to identify itself so that assistive technology, such as a screen reader program, can be used.

At step 40 the assistive technology program intercepts the event information sent from the disclosed system, and determines and/or obtains the display object currently having focus. Using the values of attributes in the display object code, such as the value of a role attribute, the assistive technology program responds to the information provided in the event, for example by generating speech audio describing a change in the user interface state. For example, the information provided by the role attribute value may indicate the type of object currently having focus, and/or characteristics of that object. For example, the assistive technology program may provide an indication that the object currently having focus is a drop-down or other menu, toolbar, spreadsheet row, or other type of display object, and generate a signal, such as speech, indicating the type of the display object. The assistive technology program may further provide indication to the keyboard user that specific predetermined keys, such as the arrow keys, can be used to traverse elements within the display object.

Thus, as illustrated in the flow chart of FIG. 2 the disclosed system may be embodied to use any specific focus event, such as the DOMFocusIn focus event, and any one or more predetermined object attributes, such as the role attribute, to make a sophisticated Web page keyboard accessible with rich assistive technology support. The disclosed system therefore advantageously promotes new patterns or idioms for vendors of assistive technology, such as screen readers, to handle complex DOM and JavaScript applications.

FIG. 2 is a flowchart illustration of methods, apparatus (s) and computer program products according to an embodiment of the invention. It will be understood that each block of FIG. 2, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Keyboard Access

Unlike mouse events, keyboard events do not always have predefined target HTML element by default. If a keyboard event, such as a Tab key press, is not handled, Web browsers normally traverse to the next HTML element that can be clicked on or have focus, such as a link, button or text area. However, as discussed above, it is often desirable to have key press access that is not limited to Tab keys when using a relatively rich Web application program. As also noted above, it is desirable to use arrow keys to traverse a menu or toolbar, or to open a menu or a drop down list provided in such Web applications. In particular, DOM and DHTML empower the use of relatively dynamic elements, such as <div> and <span>, that do not associate with any predefined key access in previous systems.

This problem is solved in one embodiment of the disclosed system by handling the DOM Document event onkeydown within DHTML, and posting the onkeydown event to appropriate user interface elements, referred to herein as display objects. The receiving display object code operates to toggle the visual representation of the display object and/or fire off other actions as appropriate.

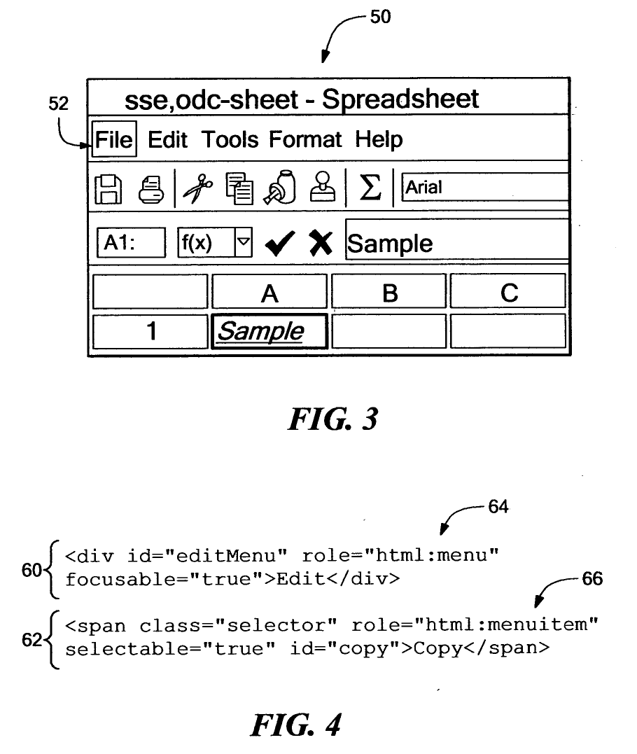

FIG. 3 shows a portion of a screen shot 50 illustrating keyboard access provided by an embodiment of the disclosed system, showing an illustrative Web application consisting of a spreadsheet editor. The embodiment of FIG. 3 associates a key press, such as the pressing by the user of a predetermined keyboard key or predetermined combination of two or more keyboard keys, with a menu object. In one embodiment, the associated key press consists, for example, of the key combination ctrl+shift+M pressed together. As shown in FIG. 3, when the associated key press occurs, the resulting key event is handled, and posted to ‘File’ menu display object code that includes a <div> element. The File menu visual representation 52 is toggled within the keyboard handler function to indicate the detected key press. Similarly, using the disclosed system, the menu, toolbar and edit state for a rich Web application can be stored and manipulated in DOM objects with JavaScript programming. This embodiment of the disclosed system supports definition of a standard keystroke combination, ctrl-shift-m, for invoking a menu or toolbar display object within a user interface. A menu or toolbar display object may accordingly be coded to respond to keyboard events. Upon receipt of a keyboard event indicating that the control, shift, and letter m keys had been pressed simultaneously, the display object code operates to present its corresponding menu or toolbar visual representation such that the user can effectively interact with it.

Assistive Technologies with Keyboard Access

An assistive technology such as screen reader is normally associated with keyboard access, because the keyboard is commonly used by a visually impaired or blind person. However, as noted above, for rich Web client applications using DOM and JavaScript, an infrastructure has not previously been available for assistive technology to ‘understand’ keyboard actions such as the one described above for handling a key press, such as the ctrl+shift+M key press. Thus screen readers have not worked correctly with DOM and JavaScript for sophisticated Web applications.

An embodiment of the disclosed system solves this problem by using the role attribute and the DOMFocusin focus event to promote patterns and idioms for the application developer, browser, and screen reader or other assistive technology to follow. With reference to the spreadsheet screen shot example shown in FIG. 3, using the role attribute, menu 60 and menu item 62 display objects can be specified as shown in FIG. 4. As shown in FIG. 4, the menu display object 60 includes a role attribute 64 having a value “html:menu” indicating that the display object 60 is a menu, while the role attribute 66 in the display object 62 has a value “html:menuitem” indicating that the display object 62 is a menu item.

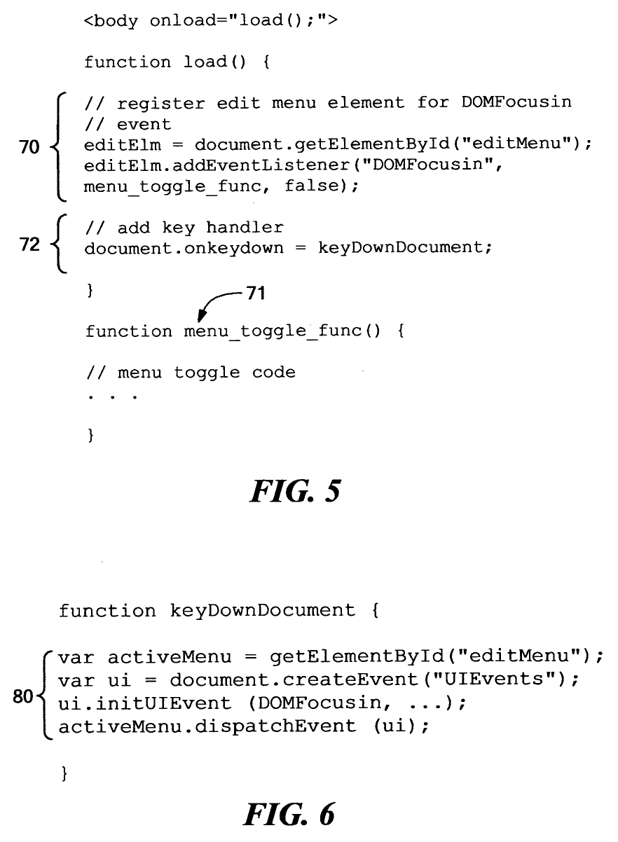

As shown in FIG. 5, in an embodiment operable with the W3C DOM event model (see Document Object Model Events—DOM 2.0, W3C Candidate Recommendation, March 2000, by Tom Pixley), the disclosed system registers the DOMFocusin focus event handler for the Edit menu as shown in the code 70, so that it can toggle the visual representation of the display object when ‘invoked’ by the corresponding key press using the menu_toggle_fnc( ) function 71. The onkeydown event handler is also registered, as shown in the code 72. Those skilled in the art will recognize that any specific code for toggling a visual representation of a display object in a user interface may be used to implement the menu_toggle_func( ) function 71, and such code is omitted from the example of FIG. 5 for purposes of clarity.

The disclosed system can then operate to post the event in the onkeydown event handler to the Edit menu using the code shown in FIG. 6. The pseudo code 80 in FIG. 6 obtains the edit menu object, creates a UIEvent, and calls initialization to specify a DOMFocusin event type. The dispatch of the event causes browser to set the current DOM focus to the edit element and invokes the corresponding handler to toggle the Edit menu display object to show its visual change. Assistive technology tools such as a screen reader can discover that the Edit menu is focused through accessibility API's supported by the given browser/OS combination, such as through MSAA (Microsoft Active Accessibility), the GNOME Accessibility Toolkit (ATK), or the like, and thus speak the role attribute defined information, in this case, “Edit menu”. Those skilled in the art may refer to “Attaching Meta-Information ROLE To XHTML Elements”, Draft September 2003, W3C, Mark Birbeck, Steven Pemberton, T.V. Raman, Richard Schwerdtfeger on how various vendors can work together to provide the best use of the role attribute.

Use Case Examples

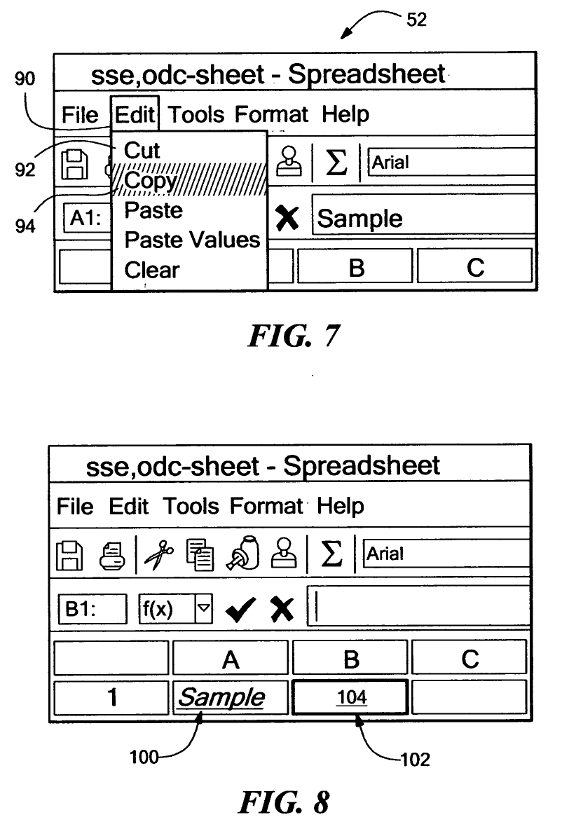

As a first use case scenario, keyboard access and screen reader operation are now described with reference to the spreadsheet Edit copy menu item as shown in FIG. 7. In this example, a user has previously pressed the key combination ctrl+shift+M to select and toggle the File menu 52. The keyboard handler set the DOMFocusIn to a File <div> menu element, and fired off the corresponding UIEvent. Subsequently, the screen reader program detected the keyboard event, and discovered the current focused element 52. The screen reader reads out appropriate text according to the role and element HTML for that element.

Next, the user pressed the Tab key to select the Edit menu 90 through the keyboard handler, and the same event handling as described above occurred, and the screen reader program read out appropriate text for that element. After the user pressed the Down Arrow key once to get to the Cut menu item 92, and then again to get to the Copy menu item 94, text for both menu items are read out by the screen reader, since the screen reader knows they are menu items responsive to the role attributes settings.

When the user presses the Enter key, the screen reader then reads text for the Copy menu item 94 selected. This can be implemented by a screen reader as an idiom according to the role of the Edit menu 90 that is a selectable element, and the common associated action with a return keystroke onto it.

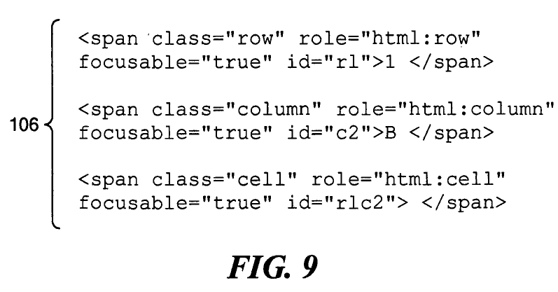

FIGS. 8 and 9 illustrate a use case involves tabbing through Spreadsheet cells. In FIG. 8, the user has pressed the Tab key from at cell A1 100, shifting the cell cursor (shown as a black border 102) to cell B1 104 through operation of the keyboard handler. The cell B1 104 and its column and row have definition of <span> elements with different roles as shown the code 106 of FIG. 9. There are three user interface (UI) changes associated with this action: highlighting of the row and column for cell B1, and drawing the black border 102 for cell B1 104. The keyboard handler may, for example, operate to dispatch one DOMFocusin event to the affected row, column and cell display elements in the code 106. Thus, a screen reader may read off the <role> attribute of the ‘row’ element by speaking ‘1’, and of the ‘column’ element by speaking ‘B’, and the content of the cell as well. Thus the <role> attribute may be used provide multiple display object meanings, as illustrated and described above.

Alternative Embodiment Using the DOM setFocus( ) Method

In an alternative embodiment, instead of posting a focus event to a display object, the keyboard handling function calls the DOM setFocus( ) method on the display object when the display object gains the current focus in the user interface. While setFocus( ) may not be currently available on all DOM elements in some existing systems, the W3C may allow for, or define setFocus( ) to be available for all DOM elements at some point. This alternative embodiment using the DOM setFocus( ) method in this way may be advantageous, in that it may be simpler than having to create and post a focus event. Moreover, the availability of DOM setFocus( ) on any DOM element may be advantageous in the area of assistive technologies, which are designed to follow the user's focus. However, this may require a change to the current DOM level 2 HTML specification, which may indicate that the DOM setFocus( ) method is only provided for anchors and form elements.

While the above description includes references to an embodiment in which a display object is bound to a focus event, such as a DOM Focusin event, the present invention is not so limited. The display object may be bound to any semantic, device independent event. For example, object activation events may be used as well and/or in addition. One example of an activation event that may be available in some circumstances and used in an alternative embodiment is the DOM Activate event. Other events may also be used, such as named XML events.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed. For example, certain browser agents could provide other focus schemes to enable focus to all HTML elements, and in this case the DOMFocusin event can be replaced by corresponding features in this new focus scheme. Moreover, while the preferred embodiments are described in connection with various illustrative program command structures, one skilled in the art will recognize that the system may be embodied using a variety of specific command structures. Accordingly, the invention should not be viewed as limited except by the scope and spirit of the appended claims.

We claim:

1. A method for providing accessibility to a Web page, comprising:
downloading, to a client computer system, at least one Web page, wherein said Web page includes a code representation of a user interface display object;
associating said user interface display object with a device independent event;
responsive to said device independent event, providing a notification to said code representation of said user interface display object; and
changing, by said code representation of said user interface display object in response to said notification, a visual representation of said user interface display object to indicate that it currently has focus within the user interface.

2. The method of claim 1, further comprising:
making said notification available to at least one assistive technology program; and
wherein said code representation of said user interface display object includes at least one attribute indicating an action associated with said user interface display object to be provided through said assistive technology program.

3. The method of claim 1, wherein said device independent event comprises a focus event.

4. The method of claim 1, wherein said device independent event comprises an activation event.

5. The method of claim 1, wherein said device independent event is generated in response to a determination that an intercepted key press matches a predetermined key press associated with said user interface display object.

6. The method of claim 1, wherein said providing said notification includes creating a focus event and posting said focus event to said code representation of said user interface display object.

7. The method of claim 1, wherein said providing said notification comprises calling a program code method that provides an indication that focus has been passed to said user interface display object.

8. The method of claim 2, wherein said action associated with said user interface display object comprises generating a speech output describing said user interface display object.

9. The method of claim 1, further comprising:
in the event that an intercepted key press matches a key press associated with a user interface navigation, providing a notification to said code representation of said user interface display object;
changing, by said code representation of said user interface display object in response to said notification, a visual representation of said user interface display object to reflect the user interface navigation associated with said key press, wherein said navigation associated with said key press causes an element within said user interface display object to have focus within the user interface; and
making said notification available to said at least one assistive technology program.

10. The method of claim 5, wherein said predetermined key press comprises pressing of the control, shift, and m keys.

11. The method of claim 10, wherein said user interface display object comprises a menu display object.

12. The method of claim 10, wherein said user interface display object comprises a tool bar display object.

13. A computer program product, wherein said computer program product includes a computer readable medium, said computer readable medium having a computer program for providing Web page accessibility stored thereon, said computer program comprising:
program code operative to download, to a client computer system, at least one Web page, wherein said Web page includes a code representation of a user interface display object;
program code operative to associate said user interface display object with a device independent event;
program code, responsive to said device independent event, operative to provide a notification to said code representation of said user interface display object; and
program code operative to change, by said code representation of said user interface display object in response to said notification, a visual representation of said user interface display object to indicate that it currently has focus within the user interface.

14. The computer program product of claim 13, further comprising:
program code operative to make said notification available to at least one assistive technology program; and
wherein said code representation of said user interface display object includes at least one attribute indicating an action associated with said user interface display object to be provided through said assistive technology program.

15. The computer program product of claim 13, wherein said device independent event comprises a focus event.

16. The computer program product of claim 13, wherein said device independent event comprises an activation event.

17. The computer program product of claim 13, wherein said device independent event is generated in response to a determination that an intercepted key press matches a predetermined key press associated with said user interface display object.

18. The computer program product of claim 13, wherein said program code operative to provide said notification is further operative to create a focus event and to post said focus event to said code representation of said user interface display object.

19. The computer program product of claim 13, wherein said program code operative to provide said notification comprises program code operative to call a program code method that provides an indication that focus has been passed to said user interface display object.

20. The computer program product of claim 14, wherein said action associated with said user interface display object comprises generating a speech output describing said user interface display object.

21. The computer program product of claim 13, further comprising:
program code operative, in the event that an intercepted key press matches a key press associated with a user interface navigation, to provide a notification to said code representation of said user interface display object;
said code representation of said user interface display object is further operative to change, in response to said notification, a visual representation of said user interface display object to reflect the user interface navigation associated with said key press, wherein said navigation associated with said key press causes an element within said user interface display object to have focus within the user interface; and
program code operative to make said notification available to said at least one assistive technology program.

22. The computer program product of claim 17, wherein said predetermined key press comprises pressing of the control, shift, and m keys.

23. The computer program product of claim 22, wherein said user interface display object comprises a menu display object.

24. The computer program product of claim 22, wherein said user interface display object comprises a tool bar display object.

25. A system for providing Web page accessibility, comprising:
means for downloading, to a client computer system, at least one Web page, wherein said Web page includes a code representation of a user interface display object;
means for associating said user interface display object with a device independent event;
means responsive to said device independent event, for providing a notification to said code representation of said user interface display object; and
means for changing, by said code representation of said user interface display object in response to said notification, a visual representation of said user interface display object to indicate that it currently has focus within the user interface.

26. A computer data signal embodied in a carrier wave, said computer data signal including at least one computer program for providing Web page accessibility, said computer program comprising:
program code operative to download, to a client computer system, at least one Web page, wherein said Web page includes a code representation of a user-interface display object;
program code operative to associate said user interface display object with a device independent event;
program code, responsive to said device independent event, operative to provide a notification to said code representation of said user interface display object; and
program code operative to change, by said code representation of said user interface display object in response to said notification, a visual representation of said user interface display object to indicate that it currently has focus within the user interface.
